(19) United States
(12) Patent Application Publication
(10) Pub. No.: US 2008/0063728 A1
(43) Pub. Date: Mar. 13, 2008

(54) Antimicrobial Glass Surfaces of Glass Powders

(75) Inventors: Jorg Hinrich Fechner, Mainz (DE); Jose Zimmer, Ingelheim (DE); Bernd Drapp, Reutlingen (DE); Frank Thoma, Russelsheim (DE)

Correspondence Address: BAKER & DANIELS LLP;111 E. WAYNE STREET, SUITE 800, FORT WAYNE, IN, 46802, US

(73) Assignee: SCHOTT AG, Mainz (DE)

(21) Appl. No.: 10/598,591

(22) PCT Filed: Sep. 30, 2004
(86) PCT No.: PCT/EP04/10923

§ 371 Date: Dec. 1, 2006

(30) Foreign Application Priority Data
Sep. 30, 2003 (DE) 103 45 815.8

(51) Int. Cl. C03C 21/00; A01N 25/34; A01N 59/16; C03C 3/087; C03C 10/00; C03C 12/00

(52) U.S. Cl. 424/618; 424/617; 424/630; 424/635; 424/641; 424/650

(57) ABSTRACT

The invention relates to a water-insoluble silicate glass powder, wherein the silicate glass powder exhibits glass particles with the following composition in percentage by weight on an oxide basis:

| | |
|---|---|
| SiO₂ | 20-80 |
| Na₂O | 5-30 |
| K₂O | 0-5 |
| P₂O₅ | 0-15 |
| B₂O₃ | 0-10 |
| CaO | 4-30 |
| MgO | 0-8 |
| Al₂O₃ | 0-7 |
| Fe₂O₃ | 0-2 |

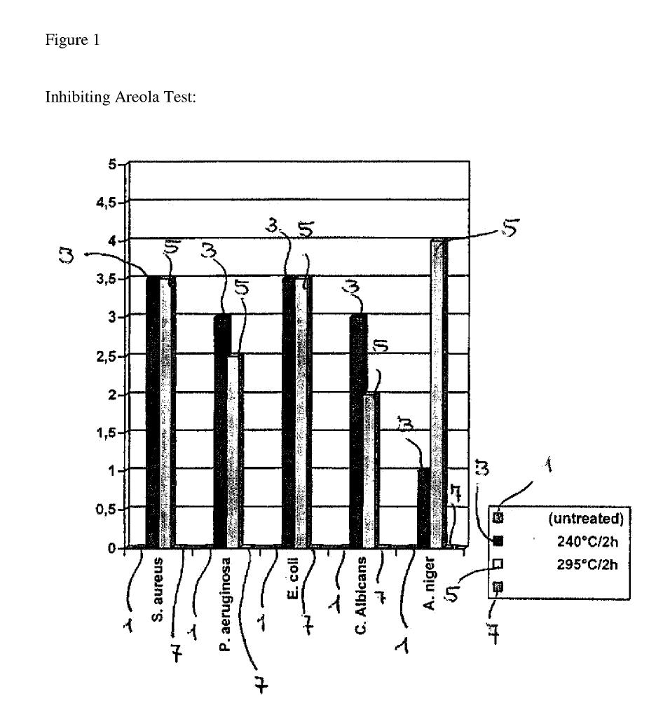

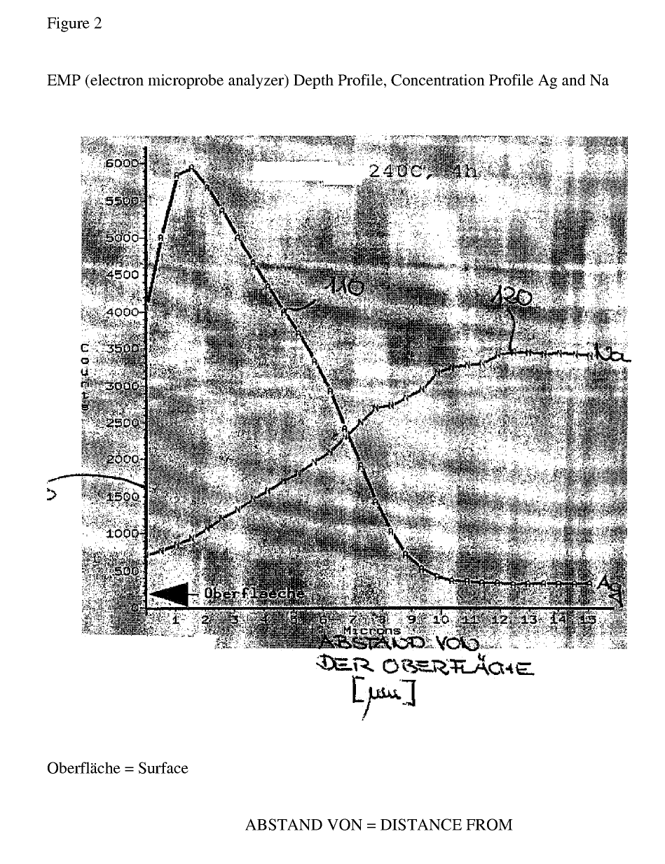

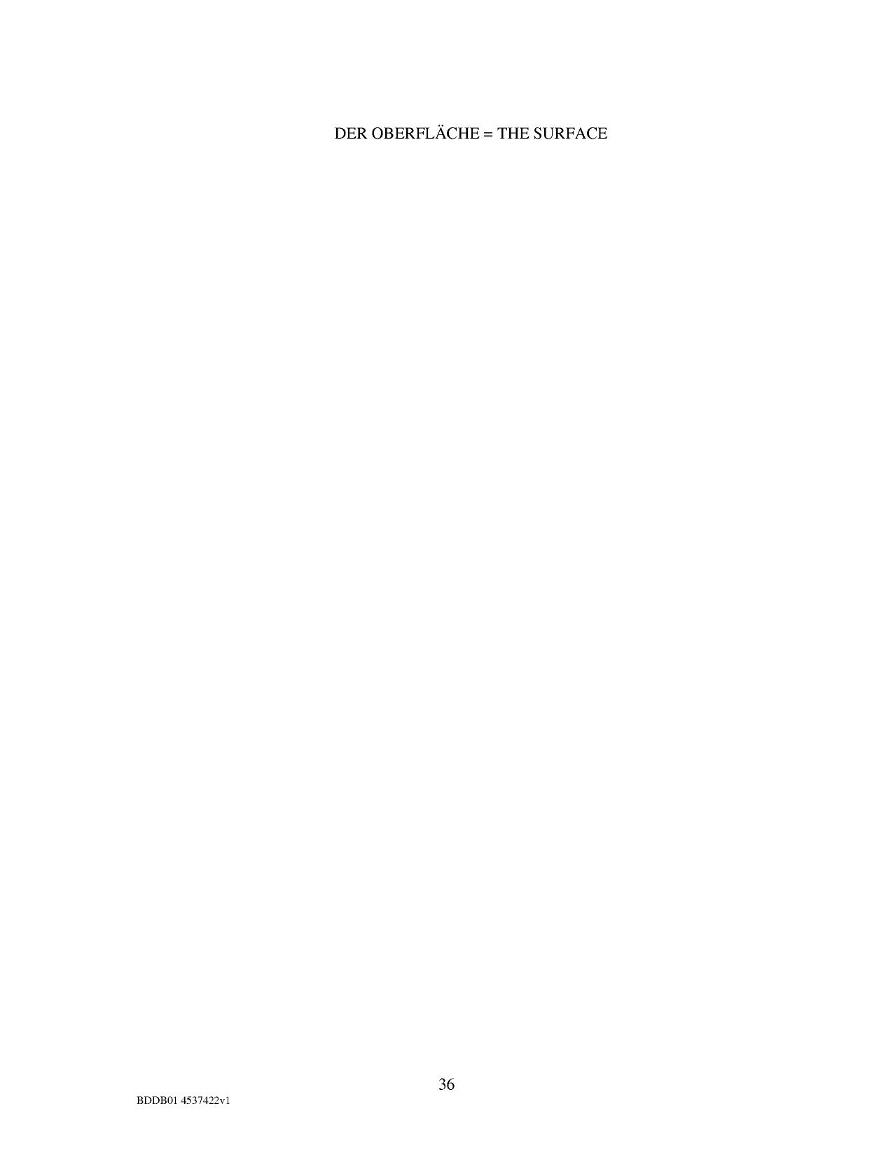

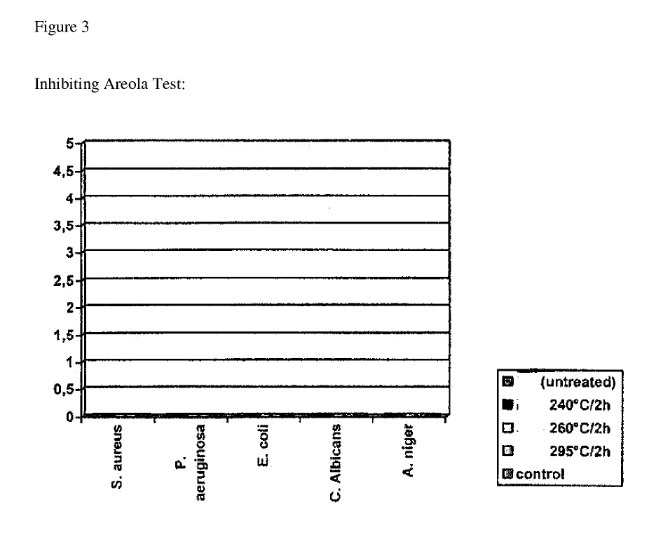

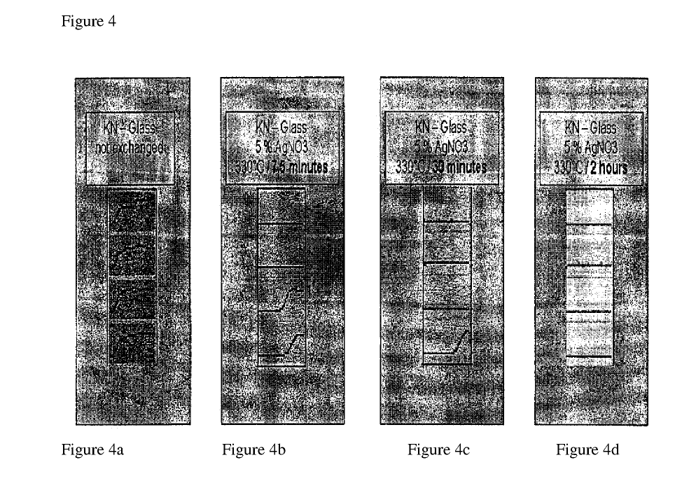

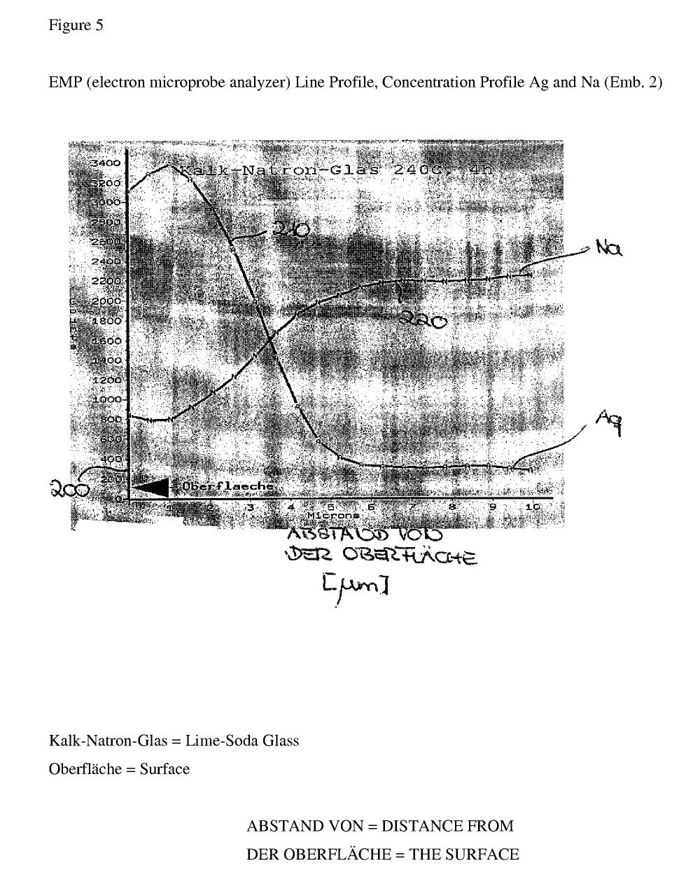

as well as conventional fining agents in conventional quantities.

The invention is characterized in that the glass particles contain at least one of the following components
ZnO
AgO
CuO
CeO₂
GeO₂
TeO₂
   wherein these components are concentrated in the regions of the glass particles that are near the surface.

The invention relates to a method for production of antimicrobial glass surfaces of extensively inert glass powders and glass ceramic powders.

The antimicrobial effect of silver ions is well known and is used in various fields such as for example in water treatment (AgCl) or in the medical field. In this connection silver is classified as largely generally recognized as safe.

Argentiferous glass powders are described e.g. in a series of publications as inorganic biocides. In this connection as a rule it is a matter of glasses with low hydrolytic resistance. The glasses at least sometimes tend to dissolve in aqueous systems or to emit very strong ions.

For example in U.S. Pat. No. 5,290,544 water-soluble glasses for applications in cosmetic products are described with very low SiO₂ and very high B₂0₃ or high P₂0₅ contents. The glasses exhibit silver concentrations greater than 0.5 percent by weight. These glasses possess an extremely low hydrolytic resistance and in addition tend to completely dissolve in water. The Ag and or Cu ions released in the process have an antibacterial effect.

In JP-A-92178433A a water-soluble glass powder is described with SiO₂<37 weight as polymer additive with high silver concentrations >1 percent by weight.

In U.S. Pat. No. 6,143,318 argentiferous phosphate glasses are described which are used as antimicrobial material for treatment of wound infections in combinations with Cu, silver and Zn. In this connection it is also a matter of water-soluble glasses which exhibit now SiO₂ concentrations and very high P₂0₅ contents.

Antimicrobial argentiferous borosilicate glasses or borophosphate glasses are described in the publications JP 10218637, JP08245240, JP 07291654, JP 03146436, JP2000264674, JP2000203876.

From WO 03/018495 water-insoluble silicate glass powders which exhibit an antimicrobial effect are known. In accordance with WO 03/018495, by the term water soluble it is understood that a base glass of a glass composition does not dissolve in water, but rather the surface only reactively exchanges ions with the surrounding water.

From DE 100 17 701, EP 1 170 264 as well as EP 0 220 333 compositions and conditions of preparation for glass ceramics have become known. The disclosure content of these publications, in particular relating to the compositions as well as to the conditions of preparation are included in their full extent in the disclosure content of the present application. The antimicrobial effect of the glasses known from WO 03/018495 is not sufficient for some applications, for example a fungicide effect in plastics.

Also ground glass ceramic powder of the compositions in the above named publications show an insufficient antimicrobial effect if one grinds these glass ceramics into glass powder.

The object of the invention is thus to provide a water-insoluble glass powder, in particular a silicate glass powder as well as a glass ceramic powder that stands out due to an increased antimicrobial effect compared to conventional glass ceramic powders as well as a method for the production of such a powder.

According to the invention in a first aspect the problem is solved by a water-soluble antimicrobial silicate glass powder, wherein the silicate glass powder exhibits glass particles with the following composition in percentage by weight on an oxide basis:

| | |
|---|---|
| SiO₂ | 20-80 |
| Na₂O | 5-30 |
| K₂O | 0-5 |
| P₂O₅ | 0-15 |
| B₂O₃ | 0-10 |
| CaO | 4-30 |
| MgO | 0-8 |
| Al₂O₃ | 0-7 |
| Fe₂O₃ | 0-2 |

as well as conventional fining agents in conventional quantities.

According to the invention the glass particles contain at least one antimicrobial component selected from the components ZnO, AgO, CuO, CeO₂, GeO₂, TeO₂, in the regions of the glass particles that are near the surface. This means that these antimicrobial components are concentrated there and their concentration on the surface is much greater than in the interior of the glass particles.

The glass contains SiO₂ as a network forming ion, preferably between 25 to 80 percent by weight. In the case of low concentrations the hydrolytic resistance decreases greatly, so that the grinding in aqueous media is no longer guaranteed without significant dissolution of the glass. In the case of higher values the crystallization stability can abate and the processing temperature is significantly increased, so that the fusion and heat forming properties deteriorate.

Na₂O is used as a fluxing agent in the case of fusion of the glass. In the case of concentrations less than 5% the melting behavior is negatively influenced. Moreover the necessary mechanism of the ion exchange no longer has sufficient effect in order to achieve an antimicrobial effect. In the case of Na₂O concentrations higher than 30 percent by weight a deterioration of the chemical resistance or hydrolytic resistance is to be observed, in particular in connection with a reduction of the SiO₂ content.

P₂0₅ is a network forming ion and can increase the crystallization stability. The concentrations should not be above 15 percent by weight, since otherwise the chemical resistance of the silicate glass decreases too greatly. P₂0₅ improves the surface reactivity of the glass.

Particularly preferable are glasses which are free from P₂0₅ right down to impurities. These glasses stand out due to a particularly high resistance.

CaO improves the chemical resistance, in particular in the slightly alkaline region and is therefore necessary in order to prevent a dissolving of the glass in aqueous media.

K2O additives promote the exchangeability of the sodium or potassium can be exchanged itself for high H+ ions.

The quantity of A1₂0₃ can be added up to a maximum of 8 percent by weight to increase the chemical resistance of the crystallization stability. ZnO is a significant component for the heat forming properties of the glass. It improves the crystallization stability and increases the surface tension. Moreover it can support the antimicrobial effect. In the case of low SiO₂ contents it increases the crystallization stability.

In order to increase the antimicrobial effect of the slightly antimicrobial base glass or of the glass ceramic, according to the invention provision is made that, after production of particles of the base glass or of the glass ceramic, these glass particles or glass ceramic particles are antimicrobially equipped with antimicrobial ions for example with the ions Ag, Cu, Ce, Ge, Te, Zn in a separate processing step.

By means of the subsequent equipping with antimicrobial ions the surface of the thus equipped glass or glass ceramic particles evinces a biocidal, in any event a biostatic effect toward bacteria, fungi or viruses. No damaging effects at all occur with regard to higher life-forms. The glass particles or glass ceramic particles provided with an antimicrobial surface in accordance with the invention can be used in particular in the foodstuffs sector, medical sector, and household sector.

The production of an antimicrobial surface of the glass or glass ceramic particles can take place in a first embodiment of the invention by means of ion exchange in salt baths.

In the case of glasses or glass ceramics which contain alkalis or alkaline earths, antimicrobial acting ions like Ag, Cu, Zn, Sn can be diffused into the surface of the glass particles or glass ceramic particles by means of ion exchange in fluid salt baths with temperatures beginning at the fusion temperature of the salt baths to nearly Tg [glass transition].

In the case of alkali-free glasses or glass ceramics simple diffusion processes can also lead to intercalation in the surface. Surprisingly this also results in sufficiently antimicrobial surfaces.

By means of different temperature cycles different depth distributions of the antimicrobial ions can be set.

Also by means of back exchange in salt baths without antimicrobial ions, e.g. Na nitrate specific effects with regard to long-term effect and strength can be achieved.

By means of tempering after the ion exchange the antimicrobial metal ions can be diffused from the surface into the interior of the glass and in a manner of speaking, “be buried”.

The antimicrobial effect can be supplemented with color effects by means of e.g. silver colloids or ionic absorption.

For preferred applications the process is conducted in such a way that no discoloration of the glasses takes place and the greatest possible transmission, preferably in the visible wavelength range, remains guaranteed.

Tensions through variable thermal expansion of the ion-exchange and the non-exchange glass can take place. This can be used in an advantageous embodiment in order for example to obtain a chemical pre-stressed glass with an antimicrobial surface.

In order to achieve sufficient antimicrobial effects in the ion exchange method according to the invention very brief treatment times are sufficient. The treatment times can be under 60 minutes, under 10 minutes or under 5 minutes.

In the case of the molten baths the treatment temperatures can range between temperatures of 50° C. above the Tg of the glasses all the way to below the melting temperatures of the salt baths.

Along with molten baths, molten pastes, for example AgCl-AgNO₃ and/or ZnCl, and/or ZnNO₃ content pastes can be applied or burned in. Applied pastes can be easily brushed off after the tempering.

By means of suitable melting and temperature control an exchange rate for example of nearly 100% can be achieved.

In an alternative embodiment of the invention instead of a surface reaction with molten salt temperature-controlled surface reactions can also be performed with inorganic or organic antimicrobial metal compounds directly or in solutions or suspensions.

The glass or glass ceramic powders provided with an antimicrobial, in particular also biocidal equipped surface with the help of the aforementioned method can exhibit glass or glass ceramic powders with particle sizes below 1 um up to ballotini with several millimeter diameters.

Through different temperature treatments, for example temperature cycles, variable depth profiles, i.e. depth distributions of the antimicrobial ions can be set.

Correspondingly treated powders can be continuously or intermittently produced in gravity, tubular or batch furnaces.

Alternately an antimicrobial embodiment of the glass or glass ceramic powder can take place with the help of suspensions. The employed suspensions can in this connection also contain solid particles like antimicrobial glasses or ceramics, which are sinter fused in the thermal process and in the case of sufficiently high concentration form a compact surface coating.

Nanoparticles of e.g. TiO₂, ZnO, CeO₂ in the suspension, which is used for antimicrobial finishing, can also be contained. Preferred are for example TiO₂ particles for achieving a photocatalytically active surface, from which antimicrobial effect proceeds. An antimicrobial surface is also obtained in the use of ZnO nanoparticles.

The burning in of the coating onto the glass powders can take place by means of conventional tempering in resistance-heated or gas-heated furnaces or with infrared radiation heating or with the help of laser radiation (e.g. CO2 laser, neodym YAG laser). The laser wavelengths and capacities must be correspondingly suitably selected.

Along with the application of the metal compounds in melts, solutions and suspensions, polymers can also be placed e.g. in the form of foils on the surface of the glass particles or glass ceramic particles and then the metal ions can be diffused and if necessary also reduced via thermal activation e.g. by means of lasers, e.g., CO₂ lasers, if necessary also locally resolved.

By means of lasers or other structuring methods defined antimicrobial structures can also be applied to the surfaces. These can for example be used in the field of biotechnology.

With the method according to the invention it is also possible, as described previously, to provide the surfaces of glass ceramic powders with an antimicrobial effect.

The glass ceramic powders can run through the process for antimicrobial finishing both before as well as after the ceramization.

Especially preferred as glass ceramics are such as described in DE 100 17 701, EP 1 170 264 or EP 0 220 333.

In particular the invention is suitable without restriction for a glass ceramic powder, wherein the source glass comprises the following composition (in percent by weight on an oxide basis):

| | |
|---|---|
| SiO₂ | 55-69 |
| Al₂O₃ | 19-25 |
| P₂O₅ | 0-1.0 |
| TiO₂ | 1.0-5.0 |
| ZrO₂ | 0.5-2.5 |
| Li₂O | 3.0-4.0 |
| Na₂O | 0-1.0 |
| K₂O | 0-0.6 |
| Σ Na₂O + K₂O | 0.2-1.0 |
| MgO | 0-1.5 |
| CaO | 0-0.5 |
| SrO | 0-1.0 |
| BaO | 0-2.5 |
| Σ CaO + SrO + BaO | 0.2-3.0 |
| ZnO | 1.0-2.2 |

as well as if necessary fining agents like As₂0₃, Sb₂O₃, SnO₂, CeO₂ and/or sulfate or chloride compounds in conventional quantities.

Quite especially preferred are source glass compositions in the following composition range:

| | |
|---|---|
| SiO₂ | 66-68 |
| Al₂O₃ | 19-25 |
| TiO₂ | 2.0-3.0 |
| ZrO₂ | 1-2.5 |
| Li₂O | 3.0-4.0 |
| Na₂O | 0-1.0 |
| K₂O | 0-0.6 |
| Σ Na₂O + K₂O | 0.2-1.0 |
| MgO | 0-1.5 |
| CaO | 0-0.5 |
| SrO | 0-1.0 |
| BaO | 0-1.0 |
| ZnO | 0-2.0 |

By tempering at 1000-1100° C. for a time of 30-10 minutes the crystallizable glass system Li2O-Al2O3-SiO2, which preferably exhibits the above cited composition, is ceramized into a glass ceramic after production of a glass block.

The ceramized glass ceramic block is ground e.g., with an antimicrobial solution and the glass ceramic powder obtained in this manner is antimicrobially finished, as described below with the help of the exemplary embodiments for silicate glasses.

The solution contained in antimicrobial ions can also be sprayed, pressed or rolled on the glass or glass ceramic particles.

The compositions contained in the melts, solutions and suspensions, which are the carriers of AG, Zn or Cu, can for example be:
Ag chloride
Ag nitrate
Ag oxide
Ag
Ag organic compounds
Ag inorganic compounds
Cu oxide
Zn oxide
Zn nitrate
Zn chloride
Cu, Zn organic compounds
Cu, Zn inorganic compounds
   as well as all other compounds, comprising in particular all salts of antimicrobially active ions, such as e.g., Ag, Cu, Zn, Sn, which are stable at room temperature or are stable up to the temperature of the tempering or in the applied solution or suspension.

Combinations of the antimicrobial substances are also possible.

Compared to Ag compounds, zinc compounds exhibit the advantage that they do not result in a significant discoloration of the glass surfaces.

By glass or glass ceramic particles, beads, fibers, granulate, flakes etc. are understood.

Preferably the antimicrobial finishing of an in principle inert glass mass can also take place when mixing or grinding the glass mass into glass particles, for example by grinding the essentially inert glass mass of a water-insoluble silicate glass after melting in a corresponding solution or suspension, e.g. in an aqueous silver nitrate solution, and then drying or firing said inert glass mass so that a more or less fixed joint is formed between antimicrobial substances and the carrier glass.

In the case of glass ceramics an antimicrobial finishing can also take place if one grinds or mixes the glass ceramic block into glass ceramic powder.

The drying can be performed for example in the form of freeze drying, microwave drying or furnace drying. The firing can for example take place continuously or intermittently in gravity furnaces, gas furnaces, chamber furnaces, rotary burners, microwave ovens, radiation furnaces.

### EXEMPLARY EMBODIMENTS

In the following the invention will be described with the help of exemplary embodiments.

In Table 1 an example of a glass composition is specified which is finished with an antimicrobial surface via ion exchange in the solution.

TABLE 1

| | Emb. 1 |
|---|---|
| SiO₂ | 71.2 |
| Al₂O₃ | 0.35 |
| CaO | 9.6 |
| MgO | 4.0 |
| Fe₂O₃ | 0.1 |
| Na₂O | 14.1 |
| K₂O | 0.05 |

In the case of the glass specified in the table it is a soda-lime glass which exhibits the composition specified in Table 1 in percentage by weight.

The glass specified in Table 1 was ground up once in an inert solution, i.e., in water. This glass powder served as a reference sample with regard to the antimicrobial activity.

In order to demonstrate the increased antimicrobial effect through the antimicrobial finishing according to the invention, the glass from Table 1 was ground in a zinc nitrate solution and in a further embodiment was ground up in a silver nitrate solution.

First the production of an antimicrobial finish with zinc ions will be described.

For this purpose 200 g of a glass in accordance with Table 1 are poured into 110 g of a 5% Zn(NO₃)₂ solution and ground or mixed for two hours in a small grinding container.

Then the obtained solution with the glass particles was dried for 19 hours in the annealing furnace at 100° C.

The pre-dried sample was then sintered for 100 minutes at 240 C so that the Zn ions could exchange with the alkali ions or diffuse in the surface of the glass particles.

The inventive method is summarized in tabular form in the following Table 2.

The finished glass particles with an antimicrobial surface comprising Zn ions are marked as Sample C.

Along with the finishing with Zn glass particles were also antimicrobially finished with Ag. The inventive method for this is given in Table 3.

For this purpose a largely inert glass with a composition in accordance with Exemplary Embodiment 1 in Table 1 was ground after melting in an AgNO₃ solution. In this connection a mass of 200 g of the glass powder was added to 100 g 5% AgNO₃ solution and ground for two hours. This relates to Sample D. In Sample E 200 g of a glass mass in accordance with Table 1, initial example 1, was ground with 10 g 5% AgNO₃ solution for two hours. In the case of Sample F 200 g of glass mass in accordance with Exemplary Embodiment 1 in Table 1 was added to 100 g 0.5% AgNO₃ solution and ground for two hours.

In the case of Sample G 200 g of a glass mass of the composition in accordance with Table 1, Embodiment 1 were added to 10 g of a 0.5% AgNO₃ solution and ground for two hours.

In the case of all Samples D, E, F as well as G after the grinding the solution comprising the ground glass particles was pre-dried for 19 hours at 100° C. so that essentially the aqueous solvent could evaporate and after that dried or sintered for 100 minutes at 240° C.

Table 4 shows the antimicrobial effect of the various samples.

In this connection the germ-killing effect of the glass powder was investigated in various compositions with the bacteria escherichia coli, pseudomonas aeruginosa, staphylococcus aureus, candida albicans, aspergillus niger.

The initial value at 0 hours designates for all samples the number of bacteria that were initially added to the culture medium. The values at 48 hours, 7 days, 14, days, 21 days, 28 days describe the number of germs that were found after addition of the silicate glass powder in a concentration of 1 percent by weight for nutrient solution for Sample A and 0.1 percent by weight glass powder for nutrient solution of Sample B. Samples A and B describe silicate glass powder which was not subsequently antimicrobially finished. These samples constitute the reference samples. As Table 4 shows, the reference samples show only a slight antimicrobial effect.

Through the subsequent finishing with Zn or Ag ions the antimicrobial effectiveness is increased as subsequently described.

The mean particle diameter of all glass powders listed in Table 4 amounted to 4 μm.

Samples C.1 and C.2 designate glass powders which were treated with a Zn(NO₃)₂ solution in accordance with Table 2 Sample C and were added in a concentration of 1 percent by weight for Sample C.1 to a nutrient solution. As can be clearly seen, an antimicrobial effect is detected for the bacteria escherichia coli, pseudomonas aeruginosa, staphylococcus aureus, since these bacteria had been completely destroyed after 14 days, resulting in a value of 0 in the corresponding table.

If one adds only 0.1 percent by weight of a glass powder which in accordance with Sample 4 in Table 2 has been finished with the antimicrobial ion zinc to the nutrient solution, the antimicrobial effect is somewhat weaker, however a complete disinfection is also achieved for the bacteria escherichia coli and pseudomonas aeruginosa, resulting in a value of 0 in the table.

As shown from Table 4 for Samples D.1 and D.2, a very strong disinfectant effect can be achieved by finishing largely inert glass powders with Ag ions.

Sample D.1 describes a glass powder finished in a 5 percent AgNO₂ solution in accordance with Table 3, Sample D. This glass powder in accordance with Sample D was added in a concentration of 0.1 percent by weight to a nutrient solution comprising the bacteria escherichia coli, pseudomonas aeruginosa, staphylococcus aureus, candida albicans, aspergillus niger.

As can be inferred from Table 4, already with a slight concentration of only 0.1 percent by weight of the antimicrobial glass powder in accordance with Sample D a disinfection is achieved for the bacteria escherichia coli, pseudomonas aeruginosa, staphylococcus aureus after 7 days. If one adds Sample D in a concentration of 1.0 percent by weight to the nutrient solution, the disinfectant effect can be demonstrated already after 48 hours for all of the examined bacteria.

Through the invention it is possible for the first time to finish soda-lime glasses, which belong to the class of water-insoluble silicate glasses, that are to be produced in large quantity quite cost-effectively and with an increased antimicrobial effect. Through the subsequent antimicrobial finishing it is possible, through corresponding selection of the concentrations, the pre-drying and tempering conditions, to selectively set the antimicrobial effect of a glass powder.

TABLE 2
Conditions for a glass powder finished with Zn ions in accordance
with Table 1

| | Glass | | | | | | | | |
|---|---|---|---|---|---|---|---|---|---|
| | powder | | Zn(NO₃)₂ | | | | | | |
| | Glass | | solution | | Mix/grind | Pre-dry | | Temper | |
| Sample | type | Mass | Conc. | Mass | Time | Time | Temp. | Duration | Temp. |
| C | Emb. 1 | 200 g | 5% | 100 g | 2 h | 19 h | 100° C. | 100 min | 240° C. |

TABLE 3
Conditions for a glass powder finished with Ag ions in accordance
with Table 1

| | Glass | | | | | | | | |
|---|---|---|---|---|---|---|---|---|---|
| | powder | | Ag(NO₃) | | | | | | |
| | Glass | | solution | | Mix/grind | Pre-dry | | Temper | |
| Sample | type | Mass | Conc. | Mass | Time | Time | Temp. | Duration | Temp. |
| D | Emb. 1 | 200 g | 5% | 100 g | 2 h | 19 h | 100° C. | 100 min | 240° C. |
| E | Emb. 1 | 200 g | 5% | 10 g | 2 h | 19 h | 100° C. | 100 min | 240° C. |
| F | Emb. 1 | 200 g | 0.5% | 100 g | 2 h | 19 h | 100° C. | 100 min | 240° C. |
| G | Emb. 1 | 200 g | 0.5% | 10 g | 2 h | 19 h | 100° C. | 100 min | 240° C. |

TABLE 4
Germicidal Effect of Different Glass Powder Samples in Nutrient
Solution containing Germs

| | | | | |
|---|---|---|---|---|
| Escherichia | Pseudomonas | Staphylococcus | | |
| coli | aeruginosa | aureus | Candida albicans | Aspergillus niger |

Sample A:
Mean particle diameter of the glass powder: 4 μm, concentration of the glass powder in
aqueous solution: 1 percent by weight powder in aqueous germ solution, reference sample
without silver

| | | | | | | |
|---|---|---|---|---|---|---|
| 0 | h | 280 000 | 320 000 | 350 000 | 290 000 | 280 000 |
| 48 | h | 500+ | 64,000+ | 700+ | 118,000+ | 160,000+ |
| 7 | days | <100+ | 2,000+ | <100+ | 80,000+ | 120,000+ |
| 14 | days | 0- | 0- | 0- | 80,000+ | 120,000+ |
| 21 | days | 0- | 0- | 0- | 80,000+ | 160,000+ |
| 28 | days | 0- | 0- | 0- | 72,000+ | 140,000+ |

Sample B:
Mean particle diameter of the glass powder: 4 μm, concentration of the glass powder in
aqueous solution: 0.1 percent by weight powder in aqueous germ solution, reference sample
without silver

| | | | | | | |
|---|---|---|---|---|---|---|
| 0 | h | 280 000 | 320 000 | 350 000 | 290 000 | 280 000 |
| 48 | h | 50,000+ | 145,000+ | 26,000+ | 327,000+ | 280,000+ |
| 7 | days | <1 mill.+ | 136,000+ | 1000+ | 182,000+ | 300,000+ |
| 14 | days | <1 mill.+ | 218,000+ | 100+ | 100,000+ | 300,000+ |
| 21 | days | 5 mill.+ | 227,000+ | <100+ | 54,000+ | 400,000+ |
| 28 | days | 9 mill.+ | 309,000+ | 0- | 48,000+ | 400,000+ |

Sample C.1:
Mean particle diameter of the glass powder: 4 μm, concentration of the glass powder: 1
percent by weight powder in aqueous germ solution, sample with zinc ions in accordance
with Table 2

| | | | | | | |
|---|---|---|---|---|---|---|
| 0 | h | 280 000 | 320 000 | 350 000 | 290 000 | 280 000 |
| 48 | h | <100+ | <100+ | <100+ | 500+ | 100,000+ |
| 7 | days | 0- | 0- | <100+ | <100+ | 80,000+ |
| 14 | days | 0- | 0- | 0- | 400+ | 26,000+ |
| 21 | days | 0- | 0- | 0- | 100+ | 26,000+ |
| 28 | days | 0- | 0- | 0- | <100+ | 18,000+ |

Sample C.2:
Mean particle diameter of the glass powder: 4 μm, concentration of the glass powder in
aqueous germ solution: 0.1 percent by weight, sample with zinc ions in accordance with
Table 2

| | | | | | | |
|---|---|---|---|---|---|---|
| 0 | h | 280 000 | 320 000 | 350 000 | 290 000 | 280 000 |
| 48 | h | 0- | <100+ | <100+ | 127,000+ | 140,000+ |
| 7 | days | 0- | 0- | <100+ | 119,000+ | 100,000+ |
| 14 | days | 0- | 0- | <100+ | 31,000+ | 80,000+ |
| 21 | days | 0- | 0- | <100+ | 25,000+ | 70,000+ |
| 28 | days | 0- | 0- | <100+ | 1.6 mill.+ | 100,000+ |

Sample D.1:
Mean particle diameter of the glass powder: 4 μm, concentration of the glass powder in
aqueous germ solution: 0.1 percent by weight, sample with silver ions in accordance with
Table 3

| | | | | | | |
|---|---|---|---|---|---|---|
| 0 | h | 280 000 | 320 000 | 350 000 | 290 000 | 280 000 |
| 48 | h | 0- | <100+ | <100+ | <100+ | 80,000+ |
| 7 | days | 0- | 0- | 0- | 2900+ | 40,000+ |
| 14 | days | 0- | 0- | 0- | 100+ | 26,000+ |
| 21 | days | 0- | 0- | 0- | 200+ | 26,000+ |
| 28 | days | 0- | 0- | 0- | 200+ | 30,000+ |

Sample D.2:
Mean particle diameter of the glass powder: 4 μm, concentration of the glass powder in
aqueous germ solution: 0.1 percent by weight, sample with silver ions in accordance with
Table 3

| | | | | | | |
|---|---|---|---|---|---|---|
| 0 | h | 280 000 | 320 000 | 350 000 | 290 000 | 280 000 |
| 48 | h | 0- | 0- | 0- | 0- | 0- |
| 7 | days | 0- | 0- | 0- | 0- | 0- |
| 14 | days | 0- | 0- | 0- | 0- | 0- |
| 21 | days | 0- | 0- | 0- | 0- | 0- |
| 28 | days | 0- | 0- | 0- | 0- | 0- |

1. Water-insoluble silicate glass powder, wherein the silicate glass powder exhibits glass particles with the following composition in percentage by weight on an oxide basis:

| | |
|---|---|
| SiO₂ | 20-80 |
| Na₂O | 5-30 |
| K₂O | 0-5 |
| P₂O₅ | 0-15 |
| B₂O₃ | 0-10 |
| CaO | 4-30 |
| MgO | 0-8 |
| Al₂O₃ | 0-7 |
| Fe₂O₃ | 0-2 |

as well as conventional fining agents in conventional quantities, characterized in that the glass particles contain at least one of the following components
ZnO
AgO
CuO
CeO₂
GeO₂
TeO₂
wherein these components are concentrated in the regions of the glass particles that are near the surface.

2. Water-insoluble, antimicrobial silicate glass powder in accordance with claim 1, characterized in that the regions near the surface contain the components in a concentration >100 ppm and <8 percent by weight.

3. Water-insoluble, antimicrobial silicate glass powder in accordance with claim 1, characterized in that the composition exhibits the following in percentage by weight on an oxide basis:

| | |
|---|---|
| SiO₂ | 38-65 |
| Na₂O | 10-30 |
| P₂O₅ | 4-15 |
| B₂O₃ | 0-3 |
| CaO | 10-30 |

4. Water-insoluble, antimicrobial silicate glass powder in accordance with claim 1, characterized in that the composition exhibits the following in percentage by weight on an oxide basis:

| | |
|---|---|
| SiO₂ | 50-80 |
| Al₂O₃ | 0-1 |
| CaO | 4-15 |
| MgO | 0-8 |
| Fe₂O₃ | 0-2 |
| Na₂O | 5-20 |
| K₂O | 0-2 |

5. Water-insoluble, antimicrobial silicate glass powder in accordance with claim 1, characterized in that the size of the particles of the glass powder is <100 μm, <50 μm, <20 μm, preferably <5 μm, especially preferably <2 μm.

6. Water-insoluble, antimicrobial silicate glass powder in accordance claim 5, characterized in that the particles with a size <5 μm can be obtained by attritor grinding of the glass in water.

7. Method for production of water-insoluble antimicrobial silicate glass powders comprising the following steps:
a silicate glass with the following composition in percentage by weight on an oxide basis:

| | |
|---|---|
| SiO₂ | 20-80 |
| Na₂O | 5-30 |
| K₂O | 0-5 |
| P₂O₅ | 0-15 |
| B₂O₃ | 0-10 |
| CaO | 4-30 |
| MgO | 0-8 |
| Al₂O₃ | 0-7 |
| Fe₂O₃ | 0-2 |

as well as conventional fining agents in conventional quantities is melted, after that the silicate glass ground is into glass particles, the glass particles are antimicrobially finished with one or more of the following ions
Zn
Ag
Cu
Ce
Ge
Te
by means of one or more of the following processing steps:
ion exchange in salt baths
application of metalliferous solutions and suspensions
firing of saline pastes
firing of metalliferous solutions and suspensions
grinding of the silicate glass into glass particles in metalliferous, in particular aqueous solutions and suspensions.

8. Method according to claim 7, characterized in that the compositions contained in the melts, solutions and suspensions, which are carriers of Ag, Zn or Cu, comprise one or more of the following compounds:
Ag chloride
Ag nitrate
Ag oxide
Ag
Ag organic compounds
Ag inorganic compounds
Cu oxide
Zn oxide
Zn nitrate
Zn chloride
Cu, Zn organic compounds
Cu, Zn inorganic compounds
as well as all other compounds, comprising in particular all salts of antimicrobially active ions, such as e.g., Ag, Cu, Zn, Sn, which are stable at room temperature or are stable up to the temperature of the tempering or in the applied solution or suspension.

9. Method according to claim 8, characterized in that one or more of the following ions Zn, Ag, Cu, Ce, Ge are concentrated in the regions of the glass particles near the surface.

10. Method in accordance with claim 8, characterized in that the size of the glass particles of the glass powder is <100 μm, <50 μgm, <20 μm, preferably <5 μm, especially preferably <2 μm.

11. Use of glass powders with antimicrobial glass surface produced according to a method in accordance with claim 8 in the foodstuffs sector.

12. Use of glass powders with antimicrobial glass surface produced according to a method in accordance with claim 8 in the household.

13. Use of glass powders with antimicrobial glass surface produced according to a method in accordance with claim 8 in pharmacy and biotechnology.

14. Use of glass powders with antimicrobial glass surface produced according to a method in accordance with claim 8 in the sector of cultivation.

15. Use of glass powders with antimicrobial glass surface produced according to a method in accordance with claim 8 in the sector of displays.

16. Use of glass powders with antimicrobial glass surface produced according to a method in accordance with claim 8 in the field of medical technology.

17. Use of glass powders with antimicrobial glass surface produced according to a method in accordance with claim 8 in the sector of hospitals and practices.

18. Use of glass powders with antimicrobial glass surface produced according to a method in accordance with claim 8 as glass bottom in cooling units, in particular in refrigerators.

19. Glass ceramic powder, wherein the glass ceramic powder comprises glass ceramic particles, characterized in that the glass ceramic particles contain at least one of the following components
ZnO
AgO
CuO
CeO₂
GeO₂
TeO₂
wherein these components are concentrated in the regions of the glass ceramic particles that are near the surface.

20. Glass ceramic powder in accordance with claim 19, characterized in that the regions that are near the surface contain the components in a concentration >100 ppm and <8 percent by weight.

21. Glass ceramic powder in accordance with claim 19, characterized in that the source glass composition of the glass ceramic exhibits the following in percentage by weight on an oxide basis:

| | |
|---|---|
| SiO₂ | 55-69 |
| Al₂O₃ | 19-25 |
| P₂O₅ | 0-1.0 |
| TiO₂ | 1.0-5.0 |
| ZrO₂ | 0.5-2.5 |
| Li₂O | 3.0-4.0 |
| Na₂O | 0-1.0 |
| K₂O | 0-0.6 |
| Σ Na₂O + K₂O | 0.2-1.0 |
| MgO | 0-1.5 |
| CaO | 0-0.5 |
| SrO | 0-1.0 |
| BaO | 0-2.5 |
| Σ CaO + SrO + BaO | 0.2-3.0 |
| ZnO | 1.0-2.2 |

22. Glass ceramic powder in accordance with claim 19, characterized in that the source glass composition of the glass ceramic exhibits the following in percentage by weight on an oxide basis:

| | |
|---|---|
| SiO₂ | 66-68 |
| Al₂O₃ | 19-25 |
| TiO₂ | 2.0-3.0 |
| ZrO₂ | 1-2.5 |
| Li₂O | 3.0-4.0 |
| Na₂O | 0-1.0 |
| K₂O | 0-0.6 |
| Σ Na₂O + K₂O | 0.2-1.0 |
| MgO | 0-1.5 |
| CaO | 0-0.5 |
| SrO | 0-1.0 |
| BaO | 0-1.0 |
| ZnO | 0-2.0 |

23. Glass ceramic powder in accordance with claim 19, characterized in that the size of the particles of the glass ceramic powder is <100 μm, <50 μm, <20 μ, preferably <5 μm, especially preferably <2 μm.

24. Glass ceramic powder in accordance with claim 19, characterized in that particles with a size <5 μm can be obtained by attritor grinding of the glass in water.

25. Method for the production of antimicrobial glass ceramic powders comprising the following steps:
a source glass is melted,
after that the source glass is ceramized into a glass ceramic
after that the glass ceramic is ground into glass ceramic particles,
the glass ceramic particles are antimicrobially finished with one or more of the following ions
Zn
Ag
Cu
Ce
Ge
Te
by means of one or more of the following processing steps:
ion exchange in salt baths
application of metalliferous solutions and suspensions
firing of metalliferous solutions and suspensions
firing of saline pastes
grinding of the glass ceramic into ceramic glass particles in metalliferous, in particular aqueous solutions and suspensions.

26. Method according to claim 25, characterized in that the compositions contained in the melts, solutions and suspensions, which are carriers of Ag, Zn or Cu, comprise one or more of the following compounds:
Ag chloride
Ag nitrate
Ag oxide
Ag
Ag organic compounds
Ag inorganic compounds
Cu oxide
Zn oxide
Zn nitrate
Zn chloride
Cu, Zn organic compounds
Cu, Zn inorganic compounds
as well as all other compounds, comprising in particular all salts of antimicrobially active ions, such as e.g., Ag, Cu, Zn, Sn, which are stable at room temperature or are stable up to the temperature of the tempering or in the applied solution or suspension.

27. Method according to claim 26, characterized in that one or more of the following ions Zn, Ag, Cu, Ce, Ge are concentrated in the regions of the glass ceramic particles that are near the surface.

28. Method in accordance with claim 25, characterized in that the size of the glass ceramic particles of the glass ceramic powder is <100 μm, <50 μm, <20 μm, preferably <5 μm, especially preferably <2 μm.

29. Use of glass ceramic powders with antimicrobial glass ceramic surface produced according to a method in accordance with claim 25 in the foodstuffs sector.

30. Use of glass ceramic powders produced according to a method in accordance with claim 25 in the household.

31. Use of glass ceramic powders produced according to a method in accordance with claim 25 in pharmacy and biotechnology.

32. Use of glass ceramic powders produced according to a method in accordance with claim 25 in the sector of cultivation.

33. Use of glass powders produced according to a method in accordance with claim 25 in the sector of displays.

34. Use of glass powders produced according to a method in accordance with claim 25 in the field of medical technology.

35. Use of glass powders produced according to a method in accordance with claims 25 through 28claim 25 in the sector of hospitals and practices.

36. Use of glass powders produced according to a method in accordance with claim 25 as glass bottom in cooling units, in particular in refrigerators.
